(19) United States
(12) Patent Application Publication
(10) Pub. No.: US 2006/0203254 A1
(43) Pub. Date: Sep. 14, 2006

(54) Measurements of an axisymmetric part including helical coil springs

(75) Inventors: Larry Sheiman, (US); Martin Somers, Raanana (IL)

Correspondence Address: DR. MARK FRIEDMAN LTD.;C/o Bill Polkinghorn, 9003 Florin Way, Upper Marlboro, MD, 20772, US

(73) Assignee: DtechXion Ltd.

(21) Appl. No.: 11/373,139

(22) Filed: Mar. 13, 2006

Related U.S. Application Data
(60) Provisional application No. 60/661,035, filed on Mar. 14, 2005.

(51) Int. Cl. G01B 11/14

(52) U.S. Cl. 356/625

(57) ABSTRACT

A computerized method for performing a measurement of an axisymmetric part such as a helical coil spring with an axis of cylindrical symmetry. Digital image data of the axisymmetric part is captured at a number of angles about the axis. For each angle, edges of the part are imaged in the digital image data, producing edge data; and eccentricity, concentricity and parallelism of the axisymmetric part is measured by calculating based on the edge data. The calculation is performed by fitting the edge data to an amplitude coefficient of a periodic function, e.g. sine function, of the angles, and the measurement is derived from the amplitude coefficients. The background of the part is illuminated which accentuates the edges. The measurement is compared with a specified tolerance of the part and a pass/fail criterion is generated and displayed.

### CROSS REFERENCE TO RELATED APPLICATIONS

This application claims benefit from US provisional application 60/661,035 filed 14-Mar. -2005 by the present inventors.

### FIELD AND BACKGROUND OF THE INVENTION

The present invention relates to a device and method for measurement of eccentricity and/or concentricity and parallelism of axisymmetric parts and specifically helical coil springs. Many industrial goods are manufactured using robotic assembly lines. Typically, sub-components of an assembly would be loaded into cassettes or magazines, which allow for more easy manipulation of the part when placed by the robot into the assembly. Whereas sub-components need to meet their design function specifications, they also have to meet certain minimum geometric tolerances so that they can “flow” through the robotic assembly process in their path to final assembly. Helical coil springs are used in virtually every product produced today: from ball point pens to computer keyboards, printers, hard drives and peripherals to medical devices to aircraft sub-components and flight critical components to motor car sub-components, suspension systems, valve assemblies and rear-view mirrors to name but a small fraction of applications. Whereas these small inexpensive passive components are relatively easy to manufacture in mass production using sophisticated CNC coiling machines, they are produced in such numbers that their geometric quality control is largely left to sampling inspection for conformance, or 100% inspection during the production process. Since springs are increasingly being assembled in robotic assembly lines, their eccentricity or concentricity have become increasingly more important if production snags due to spring flow blockages are to be prevented. Tolerances of eccentricity and concentricity have been reduced to be, in some instances, more difficult to achieve even with the most sophisticated manufacturing techniques. The result is that eccentricity/ concentricity and parallelism have become even more important spring quality characteristics than load/deflection requirements. Concentricity and parallelism have been monitored to date using two methods, namely, simple right angle blocks and feeler gauges, or using shadowgraphs. Both these systems take time (minutes per spring) and the use of methods such as feeler gauges is prone to large repeatability errors due to human handling of the gauges and the spring. It is sometimes impossible to inspect small springs (free lengths less than 10 mm) since it is not possible to hold the spring in the gauge and simultaneously manipulate a feeler gauge while searching for the maximum eccentricity. Furthermore, the current state of the art does not provide a means for the achievement of 10% six sigma quality control requirements in line with motor industry specifications for springs.

There is thus a need for, and it would be highly advantageous to have a method for measurement of eccentricity and/or concentricity and parallelism of axisymmetric parts and specifically helical coil springs

### SUMMARY OF THE INVENTION

According to the present invention there is provided an apparatus for performing a measurement of an axisymmetric part with an axis of cylindrical symmetry. The apparatus includes a rotation mechanism for rotating the part about the axis to a number of different angles, and a camera which captures digital image data of the part at the angles. A storage mechanism stores the digital image data in memory attached to a computer. A software program installed in the memory detects in said digital image data edges of the part; and the measurement is calculated based on the edges. Preferably, the measurements include eccentricity concentricity and parallelism of the part. Typically, an illumination mechanism provides uniform background illumination, (the part is between the camera and the illumination mechansim) and the uniform background illumination improves accuracy of the edge detection. Preferably, the computer is to the rotation mechanism and the rotation mechanism is synchronized with the camera.

According to the present invention there is provided, a computerized method for performing a measurement of an axisymmetric part with an axis of cylindrical symmetry. Digital image data of the axisymmetric part is captured at a number of angles about the axis. For each angle, edges of the part are imaged in the digital image data, producing edge data; and eccentricity, concentricity and parallelism of the axisymmetric part is measured by calculating based on the edge data. Preferably, the edge data is accumulated in computer memory during capture of the data. Preferably, the background of the part is illuminated which accentuates the edges. Preferably, the measurement is compared with a specified tolerance of the part and a pass/fail criterion is generated and displayed on a display attached to the computer. Preferably, the calculation is performed by fitting the edge data to an amplitude coefficient of a periodic flnction, e.g sine function, of the angles, and the measurement is derived from the amplitude coefficients. Preferably, fitting the edge data fitting is performed using a least squares numerical technique for determining the amplitude coefficient and the calculation includes determining an extreme value of the amplitude coefficient. Preferably, a second measurement of eccentricity concentricity and/or parallelism of the axisymmetric part is performed without having to invert the part along the axis.

According to the present invention there is provided a program storage device readable by a machine, tangibly embodying a program of instructions executable by the machine to perform a measurement of eccentricity, concentricity and parallelism of an axisymmetric part with an axis of cylindrical symmetry, the method as disclosed herein.

### BRIEF DESCRIPTION OF THE DRAWINGS

For a better understanding of the invention with regard to the embodiments thereof, reference is made to the accompanying drawings, in which like numerals designate corresponding elements or sections throughout, and in which:

FIG. 1 is a schematic illustration of a device for the measurement of maximum eccentricity/concentricity and parallelism of an axisymmetric part, constructed and operated in accordance with the principles of the present invention, shown with the part in situ on the turntable;

FIG. 2 is a schematic diagram of the view that the digital camera would have of the part in situ of FIG. 1;

FIG. 3 is a schematic presentation of the measurement variables eccentricity (E1), parallelism (E2) and concentricity (P);

FIG. 4 is a software flowchart showing the processing performed by computer software when the computer is connected to the device of FIGS. 1 and 2;

FIG. 5 is an actual screen shot of a spring whose top/bottom; left and right edges have been detected at a particular angular position of the turntable; and

FIG. 6 is a graph showing the eccentricity E1 captured by the software at 33 angular positions on the left and right side of the part.

### DESCRIPTION OF THE PREFERRED EMBODIMENTS

The present invention is of a system and method of for the measurement of eccentricity/concentricity and parallelism of axi-symmetric part including but not limited to helical coil springs. Specifically, the system and method includes a high-speed digital camera attached to a computer and software for the combined acquisition of the camera's digital image and the angular position control of a turntable on which the part rests. A part is placed on the turntable with its axis aligned proximate the axis of the turntable. The software grabs a frame of digital pixel data of the turntable and part's position with respect to the current angular position of the turntable. The software then evaluates the top (left and right) and bottom (left and right) periphery of the part and determines the eccentricity/concentricity and parallelism at the current angular position. The system then rotates the part by a known angular displacement and the software evaluates the eccentricity/concentricity and parallelism again. This process can be repeated until a user defined accuracy is achieved. The software uses a sine function fitting algorithm for determining the maximum eccentricity/concentricity and parallelism of the part and at the end of the test presents the maxima of all turntable position local measurements of the eccentricity/concentricity and parallelism. The speed of inspection is a function of the number of positions at which the eccentricity/concentricity and parallelism are measured and for all practical purposes is determined by the speed at which the turntable can be rotated. A typical test for eccentricity/concentricity and parallelism can be achieved within 10 seconds, while reliability and repeatability of the inspection can meet 10% six sigmna quality control requirements in line with motor industry quality specifications. Thus, in accordance with the principles of the present invention, an easy-to-use, accurate and reliable measurement device and method is provided in the form of computer controlled turntable and digital camera image data acquisition system with a sine function algorithm for the determination of the maximum eccentricity/concentricity and parallelism of an axi-symmetric part.

Other features and advantages of the invention will become apparent from the drawings and descriptions contained further herein.

It should be noted, that although the discussion herein relates to helical coil springs, the present invention may, by non-limiting example, alternatively be configured as well measuring other axisymmetric parts.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, principal intentions of the present invention are to provide a stable platform on which to place the part, provide hands free optical inspection eccentricity/concentricity and/or parallelism, and provide an algorithm for determining the maximum extent of eccentricity/ concentricity and parallelism in just 15 seconds.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

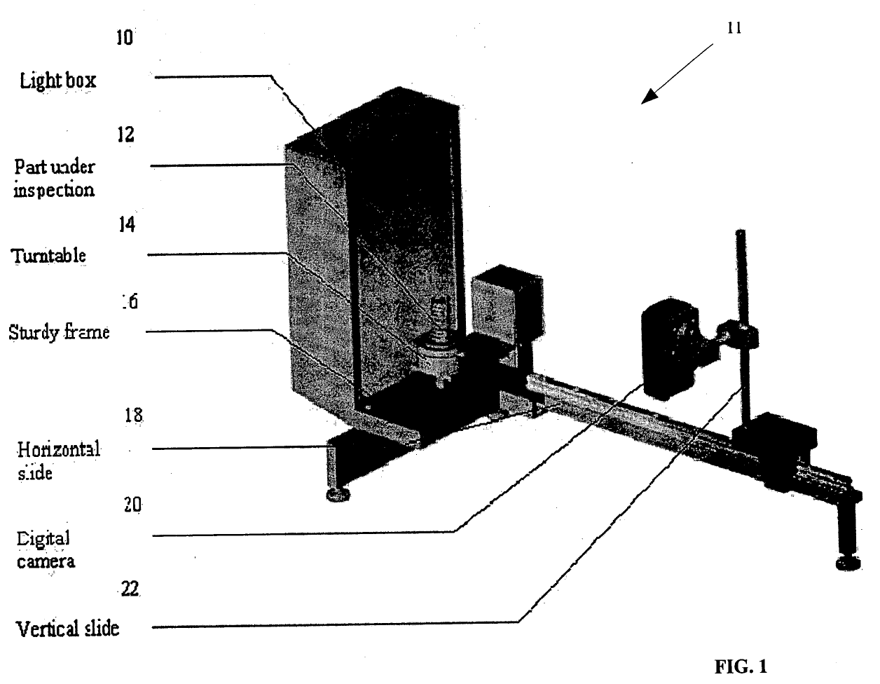

Referring now to FIG. 1, there is shown a schematic illustration of an apparatus (11) for the measurement of eccentricity/concentricity and parallelism, constructed and operative in accordance with the principles of the present invention, shown with part (12) to be inspected in situ. Apparatus (11) is designed to measure eccentricity and/or concentricity and/or parallelism after two or more angular position changes (or continuous rotation) of the turntable (14). Apparatus (11) comprises a light box (10) presenting a uniform back light, a sturdy frame (16), holding a turntable (14), a horizontal slide (18), a vertical slide (22) and a digital camera (20) in the correct orthogonal and planar orientations.

In some embodiments of the present invention, horizontal slide (18) and vertical slide (22) are set such that digital camera (20) frames part 12 to provide for optimal measurement resolution. In other embodiments of the present invention, a motorized mechanism is provided for both horizontal slide (18) and/or vertical slide (22) for automatic framing according to the size of part (12). Yet another embodiment of the device may employ motorized zoom and/or variable iris within digital camera body (22) providing an alternative or combined means for framing part (12) for optimal measurement resolution. Note that vertical slide (22) may be used to enable measurement of parts (12) whose vertical dimension is larger than the frame size of digital camera (22) by performing a known dimension shift in the vertical direction, the vertical dimension shift being tracked by a software algorithm.

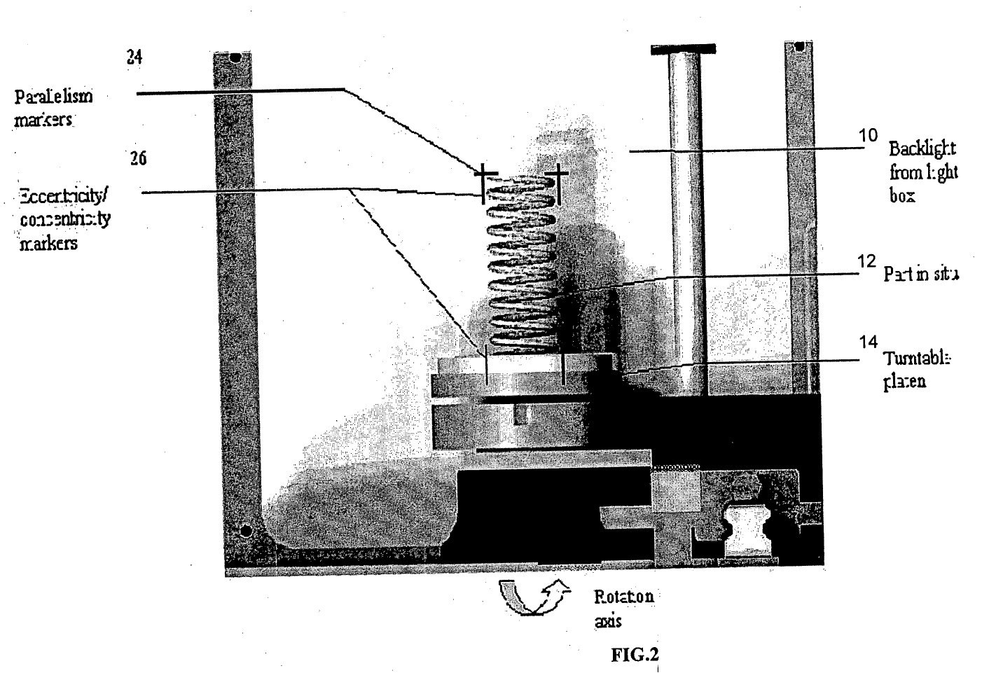

FIG. 2 shows a schematic diagram of part (12) in situ as viewed by digital camera (22). Axisymmetric part (12) is placed on turntable (14) with its axis of symmetry proximate to that of turntable (14) rotation axis. At a particular angular position of turntable (14), the top and bottom left/right edges of part (12) are detected as indicated by the eccentricity/concentricity markers (26). Similarly, parallelism markers (24) are displayed after detection of top left and right edges of part (12). Turntable (14) (according to a set angular position) then rotates part (12) and the edges thus described are again detected and stored in computer memory. An alternative method might continuously rotate turntable 12) up to 180 or 360 degrees while capturing a stream of edge data (24) and (26).

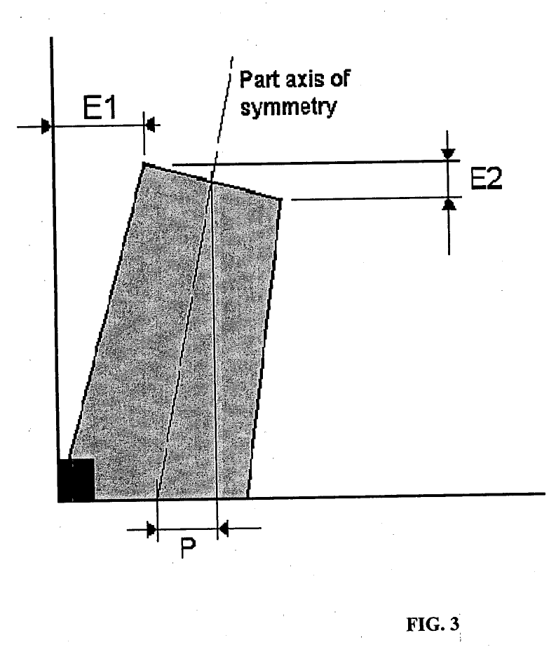

FIG. 3 provides a schematic representation of the variables E1 (eccentricity), E2 (parallelism) and P (concentricity).

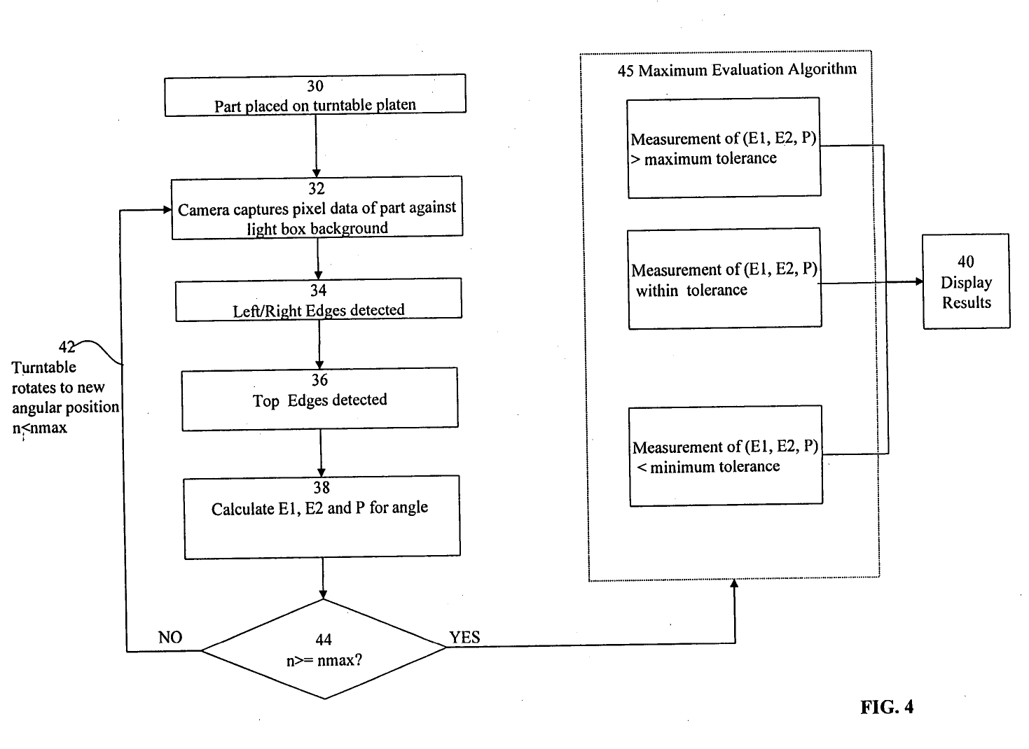

FIG. 4. is a software flow diagram representing the software program flow. With a part placed (step 30) on turntable (14) platen, the software programmed so that camera (22) captures (step 32) pixel data, of i.e. edges (24,26) of part (12) at angular position n=0. Digital camera (22) frame pixel data at angular position n=0 is captured (step 32) and stored in computer memory. The top and bottom left and right edges of part (12) are detected (step 34) and the top edges are detected (step 36) by a software edge detection algorithm. E1, E2 and P are calculated (step 38). If n<nmax (current rotational position is less than the maximum user defmed rotational position defined from the start position n=0) then steps 32 through 38 are repeated. Otherwise if n>nmax (decision block 44) (current rotational position is equal to or greater than the maximum user defined rotational position) then the rotation stops and preferably sinusoidal (SIN) based fitting algorithm is employed to determined the maximum E1 and/or E2 and/or P and is described as follows:
Var(n)=Varₘₐₓ SIN(n) Equation 1
where Var is a placeholder either E1, E2 or P and Varₘₐₓ represents the maximum of either E1, E2 or P and 0≦n≦nmax°

One method for determining Varₘₐₓ coefficient of Equation 1, is to use least squares numerical method. An alternative approach may use adjacent Var(n) values with known rotation separation to solve for the Varₘₐₓ unknown. A simple search for the maximum Var(n) can also be used given that the spatial rotational resolution is small compared with the required measurement resolution. Once Varₘₐₓ is determined a described by Equation 1, the result can be compared (step 45) to the upper and lower tolerances of each of the E1, E2 and/or P variables and the results of the measurement presented in the software user interface (40). Note that part (12) need not be turned over and measured on its other end since the top left and right edge data (for P measurement) can be used to rotate the part mathematically to determine the Varₘₐₓ for both orientations.

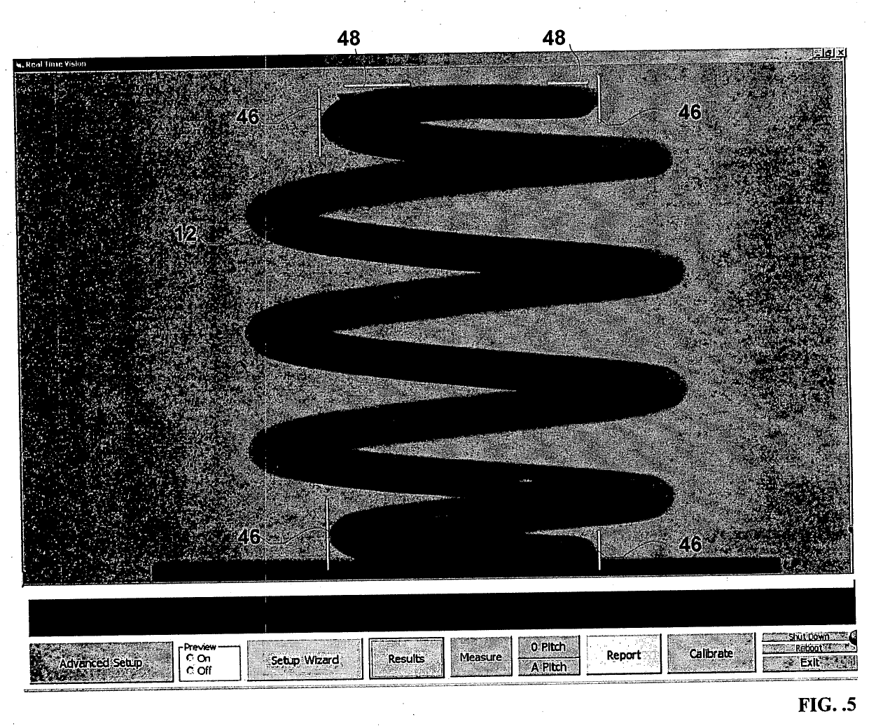

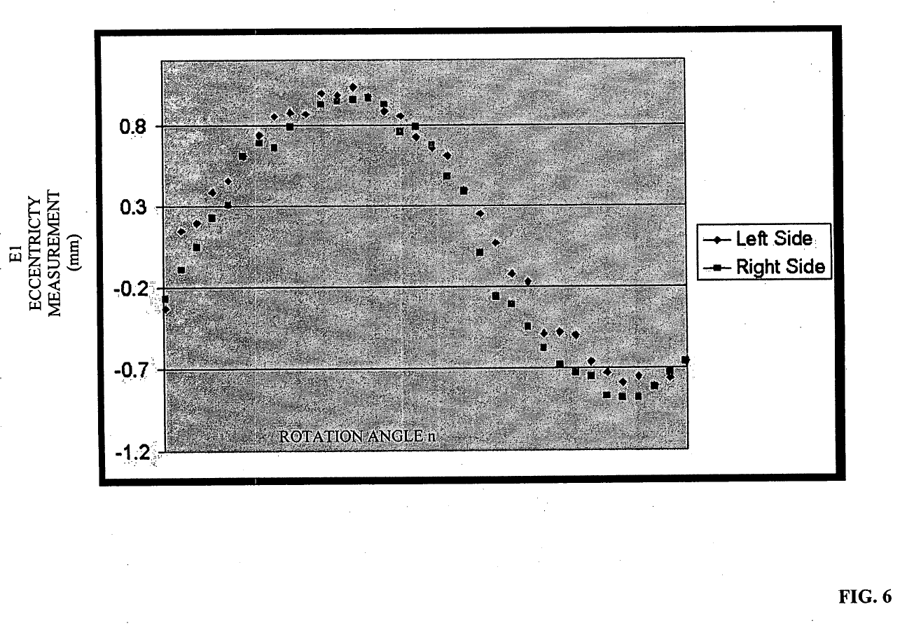

FIG. 5 is an actual screen shot of a spring whose top/bottom, left and right (46) edges (concentricity P measurement) and top left and right edges (48) (parallelism E2 measurement) have been detected at a particular angular position of the turntable. FIG. 6 shows typical sine function variant data of E1 as captured at 33 equally spaced discrete points of rotation of an axi-symmetric part.

Reference is now made to FIG. 6. FIG. 6 shows a graph illustrating the eccentricity E1 as captured by the software at 33 angular positions on the left and right side of spring (12). Eccentricity measurements are shown of both the left side and right side of spring (12), taken simultaneously while rotating spring (12). The data fits well to a sine function. The maximum eccentricity value E1 is measured to be about 1 mm.

Having described the invention with regard to certain specific embodiments thereof, it is to be understood that the description is not meant as a limitation, since further modifications may now suggest themselves to those skilled in the art, and it is intended to cover such modifications as fall within the scope of the appended claims.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

While the invention has been described with respect to a limited number of embodiments, it will be appreciated that many variations, modifications and other applications of the invention may be made.

What is claimed is:

1. An apparatus for performing a measurement of an axisymmetric part with an axis of cylindrical symmetry, the apparatus comprising:
(a) a rotation mechanism for rotating the part about the axis to a plurality of angles;
(b) a camera which captures digital image data of said part at said angles;
(c) a storage mechanism which stores said data in memory operatively attached to a computer; and
(d) a software program installed in said memory which detects in said digital image data an edge of the part;
wherein the measurement is calculated based on said edge.

2. The apparatus, according to claim 1, wherein the measurement is selected from the group consisting of eccentricity concentricity and parallelism.

3. The apparatus, according to claim 1, further comprising
(e) an illumination mechanism which provides uniform background illumination, whereby said uniform background illumination improves accuracy of the measurement.

4. The apparatus, according to claim 1, wherein said computer is operatively attached to said rotation mechanism and wherein said rotation mechanism is synchronized with said camera.

5. A method for performing a measurement of an axisymmetric part with an axis of cylindrical symmetry, the method comprising the steps of:
(a) capturing image data of the axisymmetric part at a plurality of angles about the axis;
(b) for each angle, detecting at least one edge of said part as imaged in said digital image data, thereby producing edge data; and
(c) calculating based on said at least one edge, thereby measuring at least one of eccentricity, concentricity and parallelism of the axisymmetric part

6. The method, according to claim 5, further comprising the step of:
(d) accumulating and storing said edge data during said capturing.

7. The method, according to claim 5, further comprising the step of:
(d) illuminating background of said axisymmetric part, thereby accentuating said edge.

8. The method, according to claim 5, further comprising the step of:
(d) comparing the measurement with a specified tolerance of the part, thereby generating a pass/fail criterion and displaying said pass/fail criterion on a display operatively attached to said computer.

9. The method, according to claim 5, wherein said calculating is performed by fitting said edge data to an amplitude coefficient of a periodic function of said angle, wherein the measurement is derived from said amplitude coefficient.

10. The method, according to claim 9, wherein said fitting is performed using a least squares numerical technique for determining said amplitude coefficient.

11. The method, according to claim 9, wherein said calculating includes determining an extreme value of said amplitude coefficient.

12. The method, according to claim 5, wherein said calculating includes performing a second measurement of the axisymmetric part without having to invert the part along the axis, wherein said second measurement is selected from the group consisting of eccentricity, concentricity and parallelism 13. A program storage device readable by a machine, tangibly embodying a program of instructions executable by the machine to perform a measurement of an axisymmetric part with an axis of cylindrical symmetry, the method comprising the steps of:
(a) capturing image data of the axisymmetric part at a plurality of angles about the axis;
(b) for each angle, detecting at least one edge of said part as imaged in said digital image data, thereby producing edge data; and
(c) calculating based on said at least one edge, thereby measuring at least one of measurement of the axisymmetric part, said measurement selected from the group consisting of eccentricity, concentricity and parallelism.
